(19) United States
(12) Patent Application Publication
(10) Pub. No.: US 2002/0097121 A1
(43) Pub. Date: Jul. 25, 2002

(54) Permanent magnet radial magnetizer

(76) Inventor: Herbert A. Leupold, Eatontown, NJ (US)

Correspondence Address: ATTN: AMSEL-LG-L, (John M. O'Meara Esq.), U.S. Army Communications, Electronics Command, Fort Monmouth, NJ, 07703, US

(21) Appl. No.: 10/055,391

(22) Filed: Jan. 23, 2002

Related U.S. Application Data
(63) Continuation of application No. 08/637,882, filed on Apr. 25, 1996, now abandoned.

(51) Int. Cl. H01F 7/20

(52) U.S. Cl. 335/285

(57) ABSTRACT

A permanent magnet radial magnetizer is provided for use in radially magnetizing a workpiece ring. This magnetizer includes a lower magic hemisphere and an upper magic hemisphere which have respective equatorial surfaces in oppositely facing relationship to form a gap that receives a workpiece ring to be radially magnetized, and which have respective permanent magnet toroidal flux-line pathways, and which enclose a spherical cavity containing an iron filler.

### FIELD OF THE INVENTION

The invention generally relates to magnet design and fabrication, and in particular the invention relates to a permanent magnet radial magnetizer which has a lower magic hemisphere and an upper magic hemisphere with a gap therebetween for receiving a workpiece ring to be radially magnetized.

### BACKGROUND OF THE INVENTION

In the state of the art, radially magnetized rings are used for applications such as traveling wave tubes, klystrons, and the like. Typically, high coercivity permanent magnets of toroidal or disk-like shape are difficult to magnetize radially. The difficulty arises for toroidal magnets because the thickness of the magnet is too large thus preventing sufficient flux from flowing into the toroidal hole which can then spread radially outward. This problem is discussed in U.S. Pat. No. 4,592,889 and in a U.S. Government Technical Report DELET-TR-84-5 ERADCOM 1984.

U.S. Pat. No. 4,592,889 further describes a method and apparatus for pressing and aligning radially oriented toroidal magnets. The prior art magnetizer described in U.S. Pat. No. 4,592,889 includes a magnetic flux producing means having two opposing electrical coils, two electrical insulators for embedding the coils, and a yoke member for holding a workpiece to be magnetized radially.

One problem with the prior art magnetizer is that it requires a relatively high capacity power supply.

As noted in the above report, an aligning field of 2-4 kilooersteds (kOe) is sufficient for alignment of the constituent magnetic powders during fabrication. However, a larger field is required to achieve complete magnetization. In the prior art magnetizer, described in U.S. Pat. No. 4,592,889, a high-current, opposing-coil impulse-magnetizer was used to provide nearly 10 kOe of field. However, a significant drawback of this prior art magnetizer is that it requires a current source of thousands of amperes (amps) capacity, as well as two opposing electrical coils of a plurality of winding which must be embedded in a relatively strong electrical insulator to hold the coil structure together. A metal case must also be used to provide additional strength and safety to the coil structures.

### SUMMARY OF THE INVENTION

Accordingly, it is an object of the present invention to provide a permanent magnet radial magnetizer that produces sufficient flux to radially magnetize a toroidal ring magnet and which does not require a high-capacity power supply.

This and other objects of the invention are achieved by a compact permanent magnet structure of “magic” hemispheres with a central cavity to produce a uniform high field within the cavity for radially magnetizing toroidal ring magnets. A “magic” hemisphere is a hemispherical flux source that is also referred to as a “magic igloo.” The “magic igloo” is described more fully in U.S. Pat. No. 4,835,506, which is hereby incorporated by reference. Briefly, a permanent magnet radial magnetizer according to the principles of the invention includes a lower magic hemisphere having an axis, an upper magic hemisphere coaxially aligned with and mounted in opposition to said lower magic hemisphere, said lower magic hemisphere and said upper magic hemisphere each having an equatorial surface forming a gap therebetween for receiving a workpiece ring to be radially magnetized, said lower magic hemisphere and said upper magic hemisphere each having an inner surface which forms a spherical cavity for receiving an iron fill material, and said lower magic hemisphere and said upper magic hemisphere each having a flux line pathway comprising an axial and a radial flux component within said cavity.

The use of a lower magic hemisphere and an upper magic hemisphere having respective flux pathways with coacting radial flux components avoids the problem of requiring a relatively high capacity power supply to produce a high capacity current.

### BRIEF DESCRIPTION OF THE DRAWINGS

The foregoing and other objects, features and advantages will be apparent from the following Detailed Description of the Invention as illustrated in the accompanying drawings, wherein:

FIG. 1 is a vertical sectional view of a permanent magnet radial magnetizer according to the present invention.

FIG. 2 is a vertical sectional view of a second preferred embodiment.

### DETAILED DESCRIPTION OF THE INVENTION

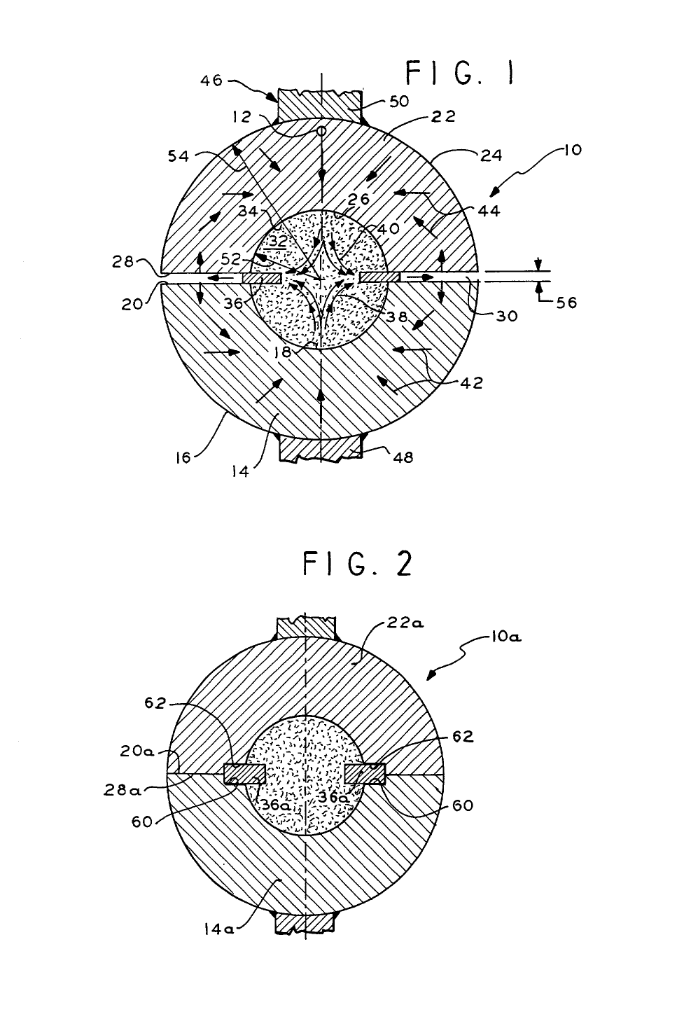

As shown in FIG. 1, a magnetizer structure or magnetizer or assembly 10 is provided. Assembly 10 is a relatively compact permanent magnet structure which does not require a high capacity power supply. Assembly 10 has a vertical axis of symmetry or axis 12. Assembly 10 has a lower magic hemisphere 14, which has an outer spherical surface 16 and an inner spherical surface 18 and a lower joint or equatorial surface 20. Assembly 10 has an upper magic hemisphere 22, which has an outer spherical surface 24 and an inner spherical surface 26 and an upper joint or equatorial surface 28. Magic hemispheres 14, 22 are permanent magnets of some high energy product rigid magnetic material (e.g., SmCo₅, Sm₂, Co₁₇, NdFeB, etc.).

Said lower magic hemisphere 14 and said upper magic hemisphere 22 are coaxially aligned with each other along axis 12 and are mounted in opposition to each other so that equatorial surfaces 20, 28 define an annular gap 30 therebetween. Said gap 30 has a gap distance 56. Inner surfaces 18, 26 form a spherical cavity 32. Cavity 32 is partly filled with a selective fill medium such as iron fill material 34. Iron fill material 34 is disposed within said cavity 32 in order to augment the generated magnetic flux. Assembly 10 receives an annular steel workpiece or ring 36, which is disposed in gap 30. Ring 36 is coaxial with magic hemispheres 14, 22 along axis 12.

Magic hemispheres 14, 22 are two permanent magnet hemispheres which are identical in magnetization orientation but which are mounted in opposition such that the resulting equatorial magnetic field faces outward. Alternatively, the magnetizations of the two permanent magnet hemispheres could be oriented in reverse so as to produce an equatorial magnetic field that faces inward. Magic hemispheres 14, 22 have respective lower and upper toroidal flux line pathways or lines 38, 40. Flux lines 38, 40 each has an axial component, and a radial component. Flux lines 38, 40 are peripherally spaced about axis 12. Lower flux lines 38 extend upwardly from lower magic hemisphere 14 in a direction approximately parallel to axis 12, and then are directed radially outwardly from cavity 32 through ring 36 approximately parallel to equatorial surfaces 20, 28. Upper flux lines 40 extend downwardly from upper magic hemisphere 22 in a direction approximately parallel to axis 12, and then are directed radially outwardly from cavity 32 through ring 36 approximately parallel to equatorial surfaces 20, 28. The directions of magnetization for both the top and bottom hemispheres of permanent magnet structure are shown by arrows 44 and 42, respectively.

Assembly 10 also comprises a jig 46 made of non-magnetic material. Jig 46 includes a lower jig portion 48, which is connected to lower magic hemisphere 14 and an upper jig portion 50, which is connected to upper magic hemisphere 22. Jig portions 48, 50 have respective connectors (not shown), such as fillet welds or threaded portions, or the like, for attaching jig portions 48, 50 to respective magic hemispheres 14, 22. Jig 46 also has an actuator (not shown) which is connected to lower and upper jig portions 48, 50. The actuator (not shown) can be an electromechanical or hydraulic type actuator. The jig 46 is adjustable in order to vary the size of gap 30. Specifically, jig 46 is used to adjust the size of gap 30 so that gap distance 56 approximately equals the thickness of workpiece ring 36.

Inner surfaces, 18, 26 have a common inner radius 52. Outer surfaces 16, 24 also have a common outer radius 54. In the preferred embodiment, the ratio of outer radius 54 to inner radius 52 is about three.

In a second preferred embodiment, equatorial surfaces 20a, 28a each have a respective recess 60, 62 (FIG. 2) formed therein to accomodate a workpiece ring 36a. Lower magic hemisphere 14a and upper magic hemisphere 22a are mounted in opposition to each other with equatorial surfaces 20a, 28a joined together in a flush relationship to each other, so that said recesses 60, 62 form an annular slot within assembly 10a. Parts of second embodiment 10a, which correspond to parts of first embodiment 10, have the same numerals but with a subscript “a” added thereto.

In operation, a ring 36 of a selective size can be placed on the lower magic hemisphere 14. Upper magic hemisphere 22 is lowered onto the top surface of ring 36 in order to attain a maximum radial magnetization field. A relatively large repulsive force between magic hemispheres 14, 22 is overcome by jig 46. Lower jig portion 48 is preferably fixed in position, and upper jig portion 50 moves axially relative thereto.

A magnet with a remanence or magnetic induction of about 12 KG is used to magnetize ring 36. Given an outer-to-inner radius ratio of about three, in combination with iron fill material 34 disposed within cavity 32 to augment the flux generated by the magnet, an outward radial field at the ring 36 is well over 1.0T. After the ring 36 is magnetized, upper magic hemisphere 22 is raised and ring 36 is removed.

The magnetic field produced by assembly 10 can be varied either by a change in the outer-to-inner radius ratio or by changing the gap distance 56 of the preferred embodiment. Moreover, ring 36 could be magnetized in a radially inward direction by two permanent magnet hemispheres that are magnetized opposite to those of assembly 10 in FIG. 1.

While the invention has been described in its preferred embodiments, it is to be understood that the words which have been used are words of description rather than limitation and that changes may be made within the purview of the appended claims without departing from the true scope and spirit of the invention in its broader aspects.

What is claimed is:

1. A permanent magnet radial magnetizer, comprising:
a lower magic hemisphere having an axis;
an upper magic hemisphere coaxially aligned with and mounted in opposition to said lower magic hemisphere;
said lower magic hemisphere and said upper magic hemisphere each having an equatorial surface forming a gap therebetween for receiving a workpiece to be radially magnetized;
said lower magic hemisphere and said upper magic hemisphere each having an inner surface which forms a spherical cavity;
said lower magic hemisphere and said upper magic hemisphere each having a flux line pathway within said cavity, said flux line pathway having an axial flux component and a radial flux component; and
selective fill medium disposed in said cavity.

2. The magnetizer of claim 1, further comprising:
a ring-shaped workpiece to be magnetized.

3. The magnetizer of claim 1, wherein
said lower magic hemisphere and said upper magic hemisphere are each a northern type of permanent magnet hemisphere, and said radial flux components are directed radially outwardly.

4. The magnetizer of claim 1, wherein
said selective fill medium is iron fill material.

5. The magnetizer of claim 1, wherein
said lower magic hemisphere and said upper magic hemisphere are each a southern type of permanent magnet hemisphere, and said radial flux components are directed radially inwardly.

6. The magnetizer of claim 1, further comprising:
a jig device having an upper jig portion connected to said upper magic hemisphere, a lower jig portion connected to said lower magic hemisphere, said upper and lower jig portions being adjustably coupled to each other for supporting said upper and lower magic hemispheres, and for varying the thickness of said gap.

7. The magnetizer of claim 1, wherein
said lower magic hemisphere and said upper magic hemisphere have respective outer surfaces with a common outer radius dimension;
said inner surfaces of said lower magic hemisphere and said upper magic hemisphere have a common inner radius dimension; and
the ratio of the common outer radius dimension to the common inner radius dimension has a selective value of about three.

8. A permanent magnet radial magnetizer, comprising:
a lower magic hemisphere having an axis;
an upper magic hemisphere coaxially aligned with and mounted in opposition to said lower magic hemisphere;
said lower and upper magic hemispheres each having an equatorial surface with a recess formed therein for receiving a workpiece to be radially magnetized;
said lower and upper magic hemispheres each having an inner surface which forms a spherical cavity;
said lower and upper magic hemispheres each having a flux line pathway within said cavity, said flux line pathway having an axial flux component and a radial flux component; and
selective fill medium disposed within said cavity.
